(19) United States
(12) Patent Application Publication
(10) Pub. No.: US 2015/0306624 A1
(43) Pub. Date: Oct. 29, 2015

(54) COATED PIPE SECTION AND METHOD OF MANUFACTURE

(71) Applicant: Progressive Products, Inc., Pittsburg, KS (US)

(72) Inventor: Todd N. Allison, Pittsburg, KS (US)

(21) Appl. No.: 14/694,168

(22) Filed: Apr. 23, 2015

Related U.S. Application Data
(60) Provisional application No. 61/983,862, filed on Apr. 24, 2014.

(51) Int. Cl. B05C 3/02; F16L 58/06; F16L 58/14; B05D 1/18

(52) U.S. Cl. CPC B05C 3/02; B05D 1/18; F16L 58/06; F16L 58/14

(57) ABSTRACT

A pipe coating system and method of manufacture. Pipe sections, such as elbows, tees, wyes, or any suitable pipe section may be placed into a coating pan and covered with an abrasive-resistant material. The material hardens, and extends the life of the pipe section, which typically becomes worn when abrasive material flows through the pipe section. A thin sheet of metal would be placed around the entirety of the coating. This metal sheet allows for patching of the coating when a hole is worn completely through the pipe wall, the coating, and the metal sheet.

### CROSS-REFERENCE TO RELATED APPLICATION

This application claims priority in U.S. Provisional Patent Application No. 61/983,862, filed Apr. 24, 2014, which is incorporated herein by reference.

### BACKGROUND OF THE INVENTION

1. Field of the Invention

The present invention relates generally to a coated pipe section and method of manufacture, and more specifically to method and resulting coated pipe immersed in an abrasive-resistant compound and sealed with a metal skin.

2. Description of the Related Art

Existing abrasion-resistant and wear-resistant pipes serve for a time, but once worn they must be replaced. It is difficult and often inefficient to patch existing pipe sections, including elbows, wyes, tees, reducers, and other sections highly susceptible to wear, especially when carrying abrasive fluent. What is needed is a method of transforming a simple pipe section into a highly-adaptable and wear-resistant section which can be easily patched before being replaced.

Heretofore there has not been available an abrasion-resistant coated pipe section and method of manufacturing the same with the advantages and features of the present invention.

### BRIEF SUMMARY OF THE INVENTION

The present invention generally provides a method of immersing a pipe section into an abrasion-resistant material such as ceramic, urethane, or a cement-based compound. The coated section is then skinned with a thin layer of sheet metal or similar product which can easily be patched or welded when the abrasive material eventually wears through the pipe, abrasion-resistant material, and original skin layer.

The immersion process can be done many times to create multiple layers of abrasion-resistant coating over a single pipe section. The process is simple and can be done on any existing pipe section which fits into an immersion tank or tub, cutting down on the need for specially manufactured abrasion-resistant pipe sections.

### BRIEF DESCRIPTION OF THE DRAWINGS

The drawings constitute a part of this specification and include exemplary embodiments of the present invention illustrating various objects and features thereof

FIG. 1 is an isometric view of a preferred embodiment of the present invention in a setup stage.

FIG. 2 is a top plan view thereof.

FIG. 3 is an isometric view showing a preferred embodiment of the present invention in a manufacturing stage.

FIG. 4 is an isometric view showing a preferred embodiment of the present invention in a coated stage.

FIG. 5 is an isometric view showing a preferred embodiment of the present invention in a covered metal skin stage.

FIG. 6 is an isometric view showing an alternative embodiment of the present invention featuring multiple layers of coating and metal skins

FIG. 7 is a sectional view of a preferred embodiment of the present invention showing wear in a pipe section.

FIG. 8 is an isometric view of a preferred embodiment of the present invention showing a leak through the coating.

FIG. 9A shows a first step in an alternative embodiment of the present invention coating and manufacturing process.

FIG. 9B shows a first step in an alternative embodiment of the present invention coating and manufacturing process.

FIG. 9C shows a first step in an alternative embodiment of the present invention coating and manufacturing process.

FIG. 10A shows an example type of pipe section, featuring a Y-shaped pipe section.

FIG. 10B shows an example type of pipe section, featuring a T-shaped pipe section.

FIG. 10C shows an example type of pipe section, featuring an elbow.

FIG. 10D shows another example type of pipe section, featuring an elbow with a deflection zone.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning

### II. Preferred Embodiment Coated Pipe Section 2

A pipe section 4, such as a wye, a tee, an elbow, or another section susceptible to wear, is placed in a coating pan 6 and immersed in an abrasion-resistant coating element 8, such as a ceramic mixture, a cement mixture, or a urethane mixture. The ends of the pipe section should extend out from the bin such that the internal portions of the pipe are left uncoated.

Once the abrasion-resistant material sets, the entire coated pipe section is removed from the bin and a sheet-metal skin is applied to the entire layer of abrasion-resistant material. This sheet metal layer is patchable, such that when the abrasive fluent eventually penetrates the pipe, the abrasion-resistant material, and the skin, the skin can easily be patched while a replacement section is fabricated.

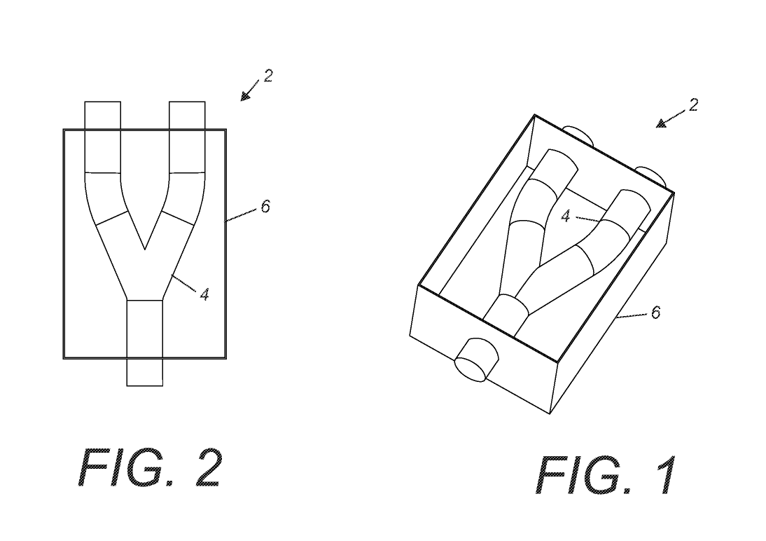

Referring to the figures in more detail, FIGS. 1 and 2 show a pipe section coating system 2 which primarily includes a coating pan 6 with a pipe section 4 inserted into the pan. Pipe ends 12 extend out beyond the coating pan 6 which allows the pipe section to be joined up to other sections of pipe (not shown).

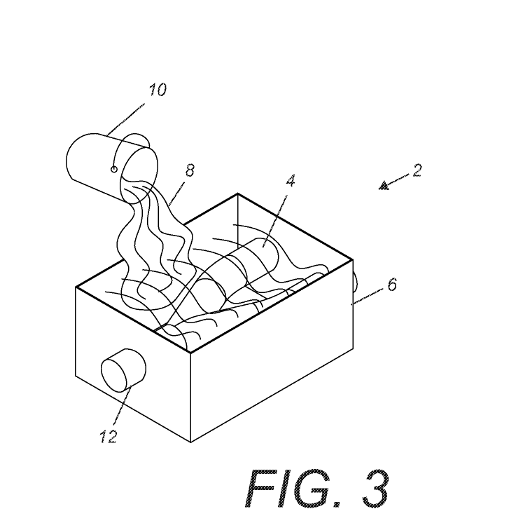

FIG. 3 shows the pipe section 4 being covered by the coating element 8, which fills the coating pan 6, completely covering the pipe section. Here the coating element 8 is shown being applied through a bucket 10, but any method of filling the coating pan 6 would suffice.

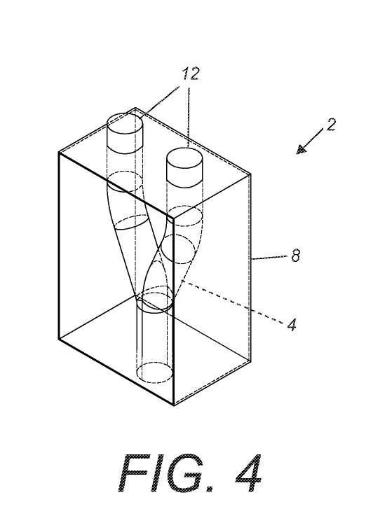

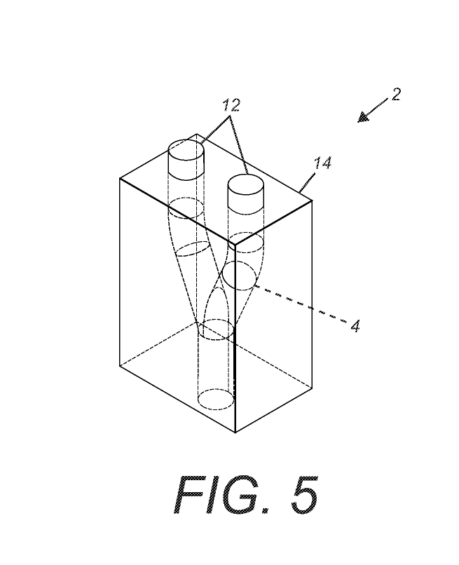

FIG. 4 shows the pipe section 4 completely encased in a hardened coating 8. The coating here is shown as removed from the pan 6. FIG. 5 shows the entirety of the coating 8 being covered in a thin sheet-metal skin 14 which provides additional resistance and the capability of patching worn holes in the coating.

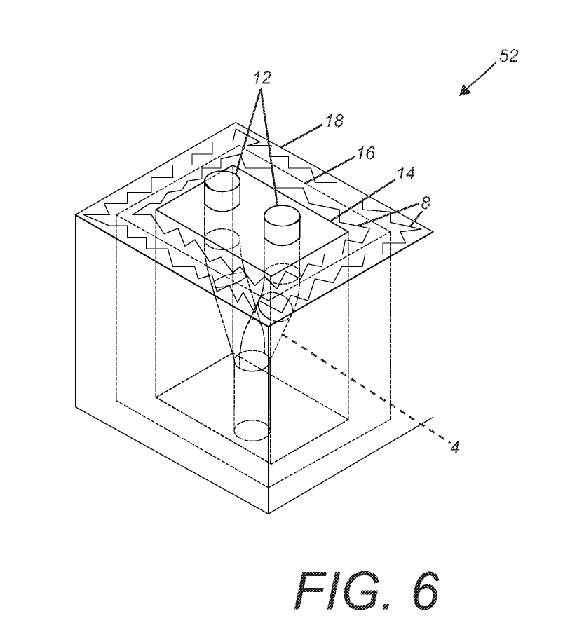

FIG. 6 shows an alternative pipe coating system 52 wherein the original coating 8 and metal skin 14 are covered by additional layers of coating 8 and additional layers of skin 16, 18, as shown. Any number of additional layers may be used.

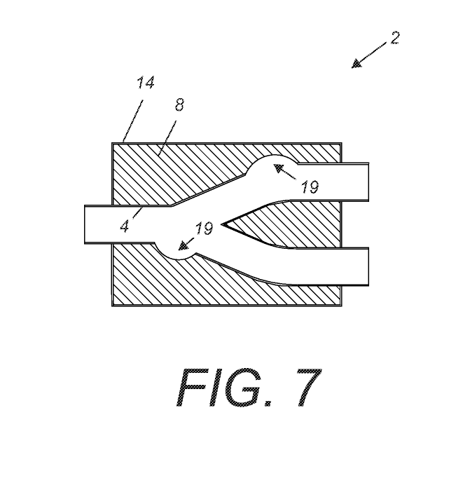

FIG. 7 demonstrates how the pipe sections 4 and coating 8 wear out when abrasive or corrosive material is fed through the pipe section. The wear areas 19 slowly erode outwards towards the metal skin 14 of the coating system 2.

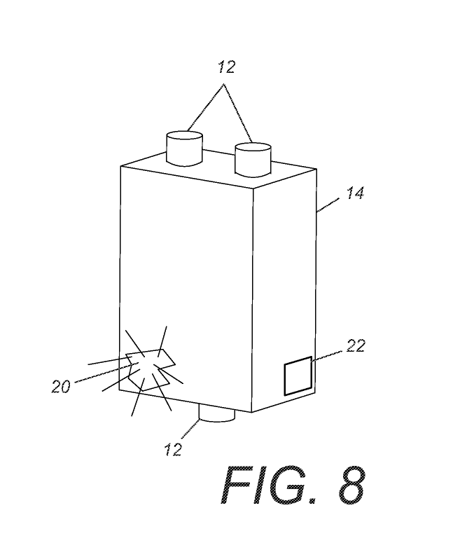

FIG. 8 demonstrates when a puncture 20 occurs, or where the coating 8 and metal skin 14 are so worn that the material breaks through and leaks out of the pipe section 4. A patch 22 can be applied to such worn areas, which allows the pipe section to continue functioning while a replacement can be manufactured. Such patching wouldn't be possible without the metal coating.

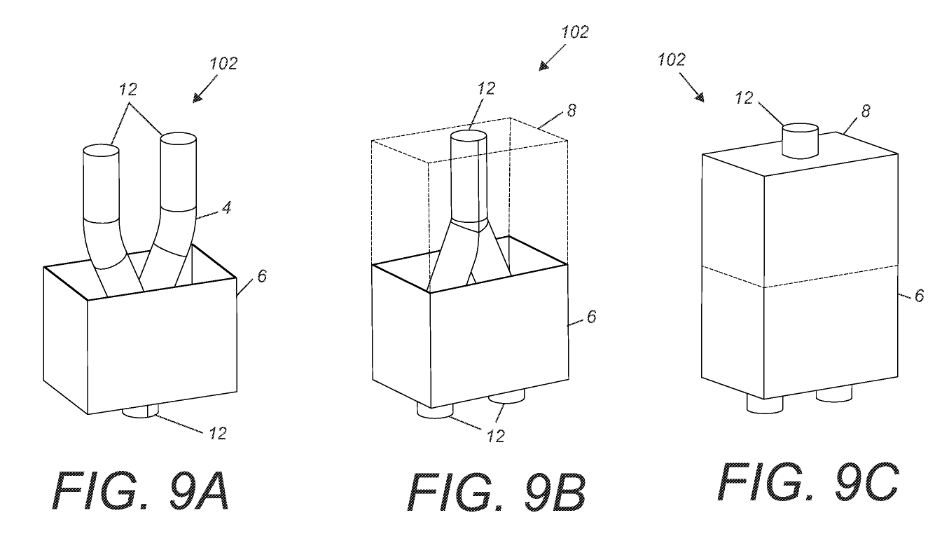

FIGS. 9A-9C demonstrate an alternative coating method 102 which includes coating multiple portions of a single pipe section 4 through multiple applications of the coating 8. 9A shows a portion of the pipe section 4 being placed in the coating pan 6, which is then filled and allowed to harden as mentioned above. Then the pipe section 4 is flipped, the remaining pipe section being placed into a coating pan 6 and coated. The result may leave a seam between the two coating portions, but this allows for smaller pans used or larger pipe sections to be coated. This is also important when dealing with awkward or difficultly shaped pieces of pipe sections which may not fit into a single pan 6.

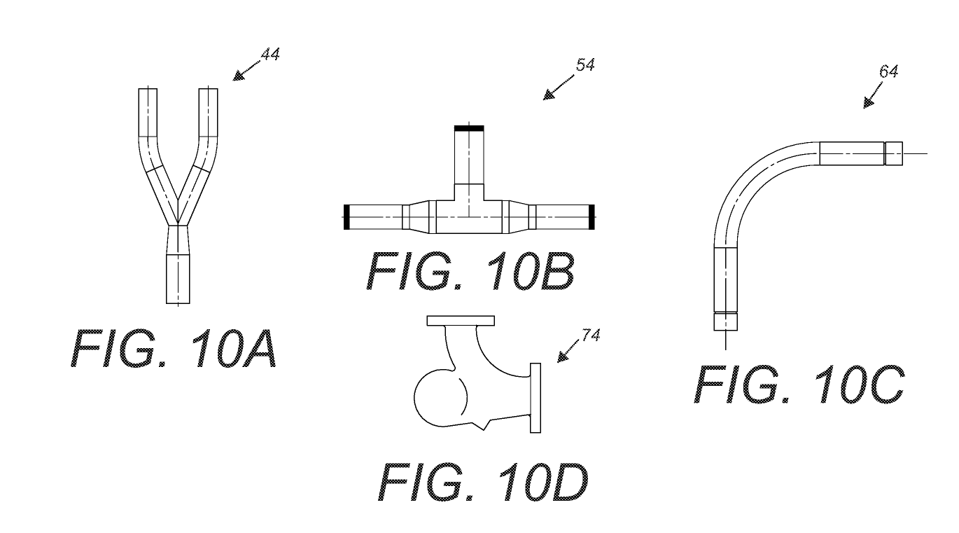

FIGS. 10A-10D show four common examples of pipe sections that could be coated using the method of coating of the present invention. FIG. 10A shows a “Y” or wye shaped pipe section 44, FIG. 10B shows a “T” or tee shaped pipe section 54, and FIG. 10C shows an elbow section 64. FIG. 10D shows an elbow with a deflection zone 74, such as the Smart Elbow® produced by HammerTek Corporation of Landisville, Pa. Sections with turns, bends, splits, or other non-straight segments are more prone to suffer from wear when abrasive material flows through the pipe due to the frictional effect of material physically contacting the walls of the pipe sections in order to turn directions. Thus, these pipe sections are prime examples of pipe sections which may benefit from the coating process, however they do not represent all of the possible examples of pipe sections which may be coated in such a manner.

This process can be used with any existing pipe section, removing the need to order and manufacture specific abrasion-resistant pipe sections every time they are needed.

It is to be understood that while certain embodiments and/or aspects of the invention have been shown and described, the invention is not limited thereto and encompasses various other embodiments and aspects.

1. A pipe coating system comprising:
a pipe section configured to transport fluent material, said pipe section comprising at least two end stubs;
a coating pan configured to receive said pipe section except for said end stubs;
a coating material configured to cover said pipe section within said coating pan, said coating material further configured to harden over time; and
a thin metal skin applied to the exterior of said coating material upon said coating material hardening.

2. The system of claim 1, wherein said pipe section is selected from the list comprising: an elbow; a “T”-shaped section; a “Y”-shaped section; and a straight section.

3. The system of claim 1, wherein said coating material comprises an ingredient selected from the list comprising: ceramic; cement; and urethane.

4. The system of claim 1, further comprising:
a metal patch configured to patch a hole in said thin metal skin.

5. The system of claim 1, wherein said fluent material comprises an abrasive fluent.

6. A method of coating a pipe section, the method comprising the steps:
placing a pipe section into a coating pan, said pipe section comprising at least two stub ends, and wherein said stub ends extend beyond said coating pan;
pouring a coating material over said pipe section and filling said coating pan;
drying said coating material such that it hardens;
removing said coating pan;
placing a thin metal skin over the exterior of said coating material;
connecting said pipe section to a pipe system; and
transporting material through said pipe system.

7. The method of claim 6, wherein said pipe section is selected from the list comprising: an elbow; a “T”-shaped section; a “Y”-shaped section; and a straight section.

8. The method of claim 6, wherein said coating material comprises an ingredient selected from the list comprising: ceramic; cement; and urethane.

9. The method of claim 6, wherein said fluent material comprises an abrasive fluent.

10. The method of claim 6, further comprising the steps:
patching a hole formed by said fluent material through said pipe section, said coating material, and said metal skin with a metal patch applied to an exterior face of said metal skin.
